(19) United States
(12) Patent Application Publication
(10) Pub. No.: US 2024/0305924 A1
(43) Pub. Date: Sep. 12, 2024

(54) Speaker and Speaker Attachment Structure

(71) Applicants: FOSTER ELECTRIC COMPANY, LIMITED, Tokyo (JP); Denso Corporation, Aichi (JP)

(72) Inventors: Akinori Matsunaga, Akishima-shi, Tokyo (JP); Hirofumi Onohara, Akishima-shi, Tokyo (JP); Tomohisa Yoshida, Akishima-shi, Tokyo (JP)

(21) Appl. No.: 18/039,263

(22) PCT Filed: Nov. 25, 2021
(86) PCT No.: PCT/JP2021/043292

§ 371 Date: May 29, 2023

(30) Foreign Application Priority Data
Nov. 30, 2020 (JP) 2020-198974

(51) Int. Cl. H04R 1/28

(52) U.S. Cl. CPC H04R 1/2896; H04R 2499/13

(57) ABSTRACT

A speaker includes a speaker unit and a holding member that holds the speaker unit. Here, the holding member is made of a resilient material and has a holding portion that holds the speaker unit and an attachment portion that is provided integrally with the holding portion and is fixed to a rear case.

### TECHNICAL FIELD

The present disclosure relates to a speaker and to a speaker attachment structure.

### BACKGROUND ART

Japanese Patent Application Laid-open (JP-A) No. 2005-20292 discloses a speaker device in which a speaker unit is attached to a door inner panel (attachment target) of a vehicle. In this speaker device, an insulator for attaching the frame of the speaker unit to the door inner panel is provided with a resilient member, and the resilient member absorbs vibration transmitted from the speaker unit to the door inner panel. As a result, the configuration suppresses the emission of unnecessary sounds such as “chattering noise” from the door inner panel that are due to the vibration of the speaker unit.

### SUMMARY OF THE INVENTION

### Problem to be Solved by the Invention

However, with the technique described in JP-A No. 2005-20292, since a resilient member is required for each insulator, there is the problem that the number of parts increases and the assembly operation becomes complicated.

The present disclosure, in consideration of the above-described problems, aims to provide a speaker that can suppress the emission of unnecessary sound due to vibration transmitted from the speaker, and in addition, that can simplify the operation of assembling the speaker together with the attachment target.

### Means for Solving the Problem

A speaker according to a first aspect is a speaker including a speaker unit and a holding member configured to hold the speaker unit, in which the holding member is formed of a resilient material, and has a holding portion configured to hold the speaker unit and an attachment portion provided integrally with the holding portion and configured to be fixed to an attachment target.

According to the first aspect, a speaker includes a holding member made of a resilient material, and a speaker unit that is held by the holding member. The holding member has a holding portion that holds the speaker unit, and an attachment portion that is provided integrally with the holding portion and is fixed to the attachment target. That is, the configuration is such that the speaker unit is fixed to the attachment target via an attachment portion formed of a resilient material. As a result, since vibration of the speaker unit is absorbed by the attachment portion, vibration is less likely to propagate to the attachment target. As a result, it is possible to suppress unnecessary sound emitted from the attachment target owing to vibration transmitted from the speaker unit. Further, by integrally providing the attachment portion and the holding portion, the number of parts can be reduced, and the operation of assembling the speaker to the attachment target can be simplified.

A speaker according to a second aspect is the configuration according to the first aspect, in which the holding member has an enclosure portion that surrounds a rear face of the speaker unit.

According to the second aspect, the rear face of the speaker unit is surrounded by an enclosure portion. As a result, the holding member configures a “sealed” enclosure. In this kind of sealed enclosure, the internal volume of a rear space (back chamber) of the speaker unit can be arbitrarily set in accordance with the size and shape of the enclosure portion, and the acoustic characteristics of the speaker can be adjusted. Accordingly, adjustment of the acoustic characteristics can be completed at the stage of design of the speaker, and the inconvenience of adjusting the acoustic characteristics at the side of the attachment target can be avoided.

A speaker according to a third aspect is the configuration according to the first aspect or the second aspect, in which a rectangular groove configured to hold an outer peripheral portion of the speaker unit is formed at the holding portion.

According to the third aspect, the outer peripheral portion of the speaker unit is held by a rectangular groove formed at the holding portion. Here, since the holding portion of the present aspect is made of a resilient material, the elastic restorative force of the holding portion can be used to bring the side face of the rectangular groove into close contact with the outer peripheral portion of the speaker unit. Therefore, it is possible to ensure airtightness between the holding portion and the speaker unit, and it is possible to suppress deterioration of sound pressure and sound quality due to air leakage.

A speaker according to a fourth aspect is the configuration according to the third aspect, in which a linear projection protruding toward the outer peripheral portion is formed at a side face of the rectangular groove, and the holding portion closely contacts the outer peripheral portion via the linear projection.

According to the fourth aspect, by providing a linear projection protruding toward the outer peripheral portion of the speaker unit at the side face of the rectangular groove, part of the side face of the rectangular groove can be actively brought into close contact with the outer peripheral portion of the speaker unit. As a result, airtightness between the holding portion and the speaker unit can be reliably obtained.

A speaker according to a fifth aspect is the configuration according to any one of the first to fourth aspects, in which a fixing portion, configured to be inserted into an attachment hole formed in the attachment target and fixed, is provided at the attachment portion.

According to the fifth aspect, the configuration is such that the holding member is fixed to the attachment target by inserting the fixing portion, integrally provided with the attachment portion, into an attachment hole of the attachment target. As a result, tools such as a screwdriver are not required when fixing the holding member to the attachment target, whereby the assembly operation of the speaker to the attachment target can be further simplified.

A speaker attachment structure according to a sixth aspect is a speaker attachment structure for attaching the speaker according to any one of the first to fourth aspects to an attachment target, in which an accommodation recess is formed at the attachment target, and the attachment portion of the holding member is fixed to the attachment target in a state in which the holding member is embedded in the accommodation recess.

According to the sixth aspect, the holding member of the speaker is fixed to the attachment target in a state of being fitted into an accommodation recess formed in the attachment target. As a result, it is possible to reduce unevenness at the surface of the attachment target, and it is possible to inhibit the speaker from interfering with a member peripheral to the attachment target.

### Effect of the Invention

According to the present disclosure, it is possible to provide a speaker and an attachment structure for the speaker that can suppress the emission of unnecessary sound due to vibration transmitted from the speaker, and that can simplify the assembly operation of the speaker to the attachment target.

### BRIEF DESCRIPTION OF THE DRAWINGS

FIG. 1 is a cross-sectional view showing an overall structure in which a speaker according to the present embodiment is attached to an attachment target.

FIG. 2 is an exploded perspective view of a speaker according to the present embodiment.

FIG. 3A is a cross-sectional view showing a state before a speaker unit according to the present embodiment is attached to a holding member, and

FIG. 3B is a cross-sectional view showing a state in which the speaker unit is attached to the holding member and held by the holding member.

FIG. 4 is a diagram showing a modified example of a holding member according to the present embodiment.

FIG. 5 is a diagram showing a modified example of a holding member according to the present embodiment.

### BEST MODE FOR CARRYING OUT THE INVENTION

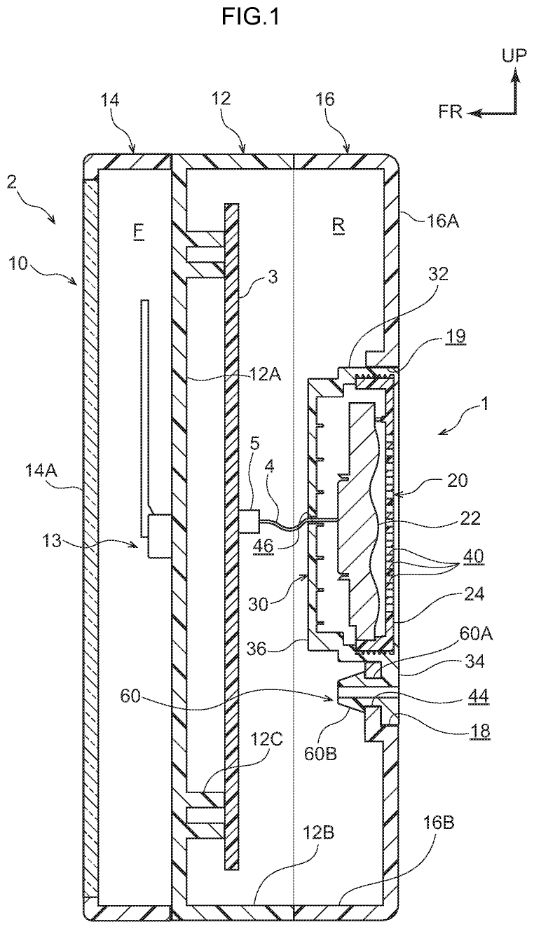

A speaker 1 according to the present embodiment is described below with reference to FIGS. 1 to 5. As an example, the speaker 1 is mounted onto a meter device 2 installed in a vehicle. In FIG. 1, for convenience of explanation, the front side of the device facing the interior of the vehicle is indicated by an arrow FR, and the upper side of the device is indicated by an arrow UP. Further, the same or equivalent components and portions are given the same reference numerals in each drawing.

### Overall Configuration

As shown in FIG. 1, the meter device 2 is installed at an instrument panel located in front of the driver in the interior of a vehicle (not shown). Further, the meter device 2 has a case 10 inside which a meter board 3 is accommodated. The case 10 as a whole is formed in the shape of a box that is flat in the front-rear direction, and has a meter case 12 that divides the internal space into front and rear portions. A front case 14 is provided at the front side of the meter case 12, and a front space F is formed between the meter case 12 and the front case 14. A rear case 16 is provided at the rear side of the meter case 12, and a rear space R is formed between the meter case 12 and the rear case 16.

The meter case 12 is formed in a box shape that is open to the rear side, and has a front vertical wall portion 12A whose plate thickness direction is the front-rear direction, and a side wall portion 12B standing rearward from a peripheral edge of the front vertical wall portion 12A. A meter display unit 13 that displays measured values of various measurement instruments installed in the vehicle is formed at the front side (rear side of the vehicle) face of the front vertical wall portion 12A. The meter display unit 13 is configured to be visible to passengers in the vehicle cabin through a transparent window portion 14A provided in the front case 14.

Further, a board support portion 12C is provided at an inner side of the side wall portion 12B of the meter case 12, and the board support portion 12C supports the meter board 3. A control device (not shown) that receives signals from various measurement devices installed in the vehicle is mounted at a mounting face on the front side of the meter board 3. Further, a mounting face on the rear side of the meter board 3 faces the speaker 1, which is described below, and wiring 4 extending from the speaker 1 is connected to the mounting face via a connector 5. Electronic components necessary for controlling the speaker 1 are mounted to the mounting face of the meter board 3 to which the connector 5 is connected.

The rear case 16 is formed in a box shape that is open to the front side, and has a rear vertical wall portion 16A whose plate thickness direction is the front-rear direction, and a side wall portion 16B standing forward from a peripheral edge of the rear vertical wall portion 16A. An accommodation recess 18 recessed inside the rear case 16 is formed in the rear vertical wall portion 16A. Further, a substantially circular opening 19 is provided in the center of the accommodation recess 18. The configuration is such that a holding member 30, which is described below, is fitted into the accommodation recess 18 in a state in which the speaker unit 20 is held inside the holding member 30. Further, in this state, the holding member 30 is configured to not protrude from the surface of the rear case 16. The speaker 1 is described in detail below.

### Speaker

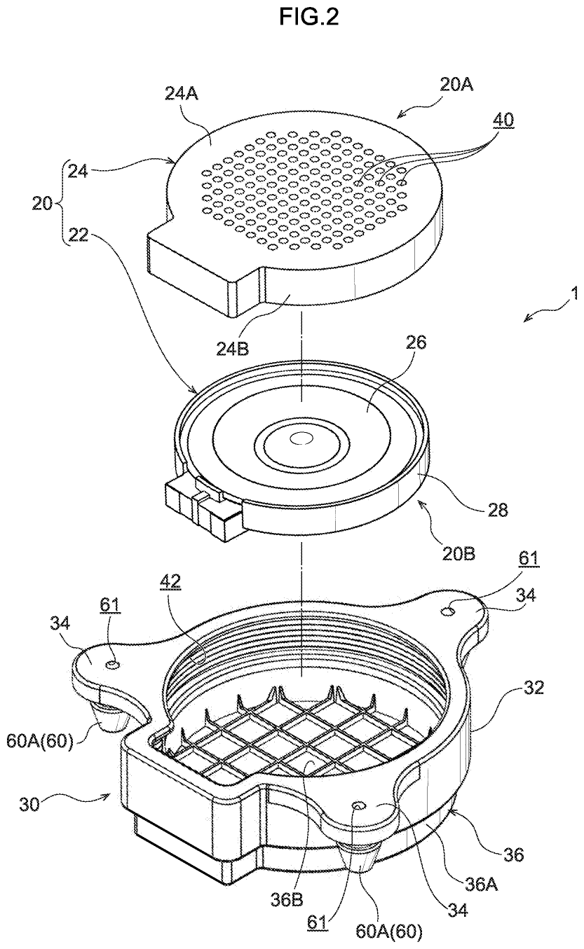

FIG. 2 shows an exploded perspective view of the speaker 1. As shown in FIG. 2, the speaker 1 includes a speaker unit 20 that outputs an acoustic signal (sound wave) by vibrating a diaphragm 26, and the holding member 30 that holds the speaker unit 20. The speaker 1 of the present embodiment is attached to the meter device 2 in an orientation such that the front face 20A of the speaker unit 20 faces the rear side of the meter device 2 (see FIG. 1).

### Speaker Unit

The speaker unit 20 has a main body 22 having a diaphragm 26, and a front cover 24 attached to the main body 22.

The main body 22 includes the diaphragm 26 and a magnetic circuit (not shown), and a frame 28 that supports the diaphragm 26 and the magnetic circuit is attached to the rear side of the diaphragm 26. The diaphragm 26 is arranged at the front face of the main body 22 (on the side of the front face 20A of the speaker unit 20). Further, the frame 28 is arranged at the rear face of the main body 22 (on the side of the rear face 20B of the speaker unit 20).

The front cover 24 includes a front face portion 24A that covers the front face of the main body 22 and a side face portion 24B that covers the radial outer side face of the main body 22. The front cover 24 is made of resin, for example. The front face portion 24A is formed in a circular plate shape whose plate thickness direction is the axial direction (amplitude direction) of the speaker 1, and is arranged in opposition to the front face of the main body 22. Plural through-holes 40 are formed in the front face portion 24A, and the inside and outside of the front cover 24 are communicated with each other through these through-holes 40. The side face portion 24B stands from the peripheral edge of the front face portion 24A toward the rear face side of the main body 22. The side face portion 24B is fitted to the outer peripheral portion of the main body 22 with a fitting claw (not shown) formed on an inner peripheral face thereof.

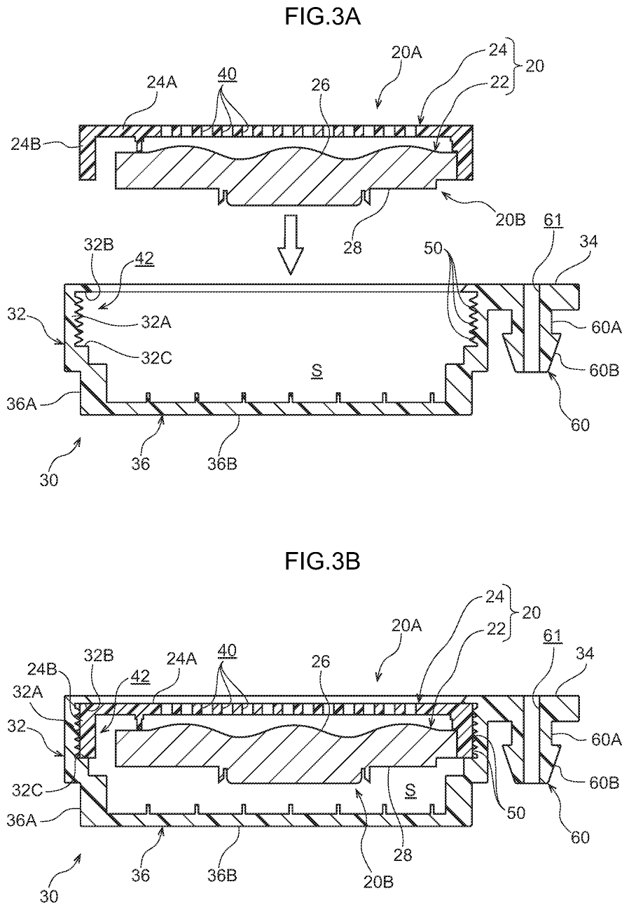

In this way, the speaker unit 20 is housed in the holding member 30 (described below) after the main body 22 and the front cover 24 are integrated in advance, as shown in FIG. 3A (refer to FIG. 3B). The front cover 24 is not essential for the speaker unit 20, and the speaker unit may be configured without the front cover.

### Holding Member

The holding member 30 is made of a resilient material, and a holding portion 32, an attachment portion 34, and an enclosure portion 36 are integrally formed. The holding member 30 holds the speaker unit 20 and configures an enclosure for the speaker 1.

As shown in FIGS. 1 and 3, the holding portion 32 of the holding member 30 has the function of holding the outer peripheral portion of the speaker unit 20. Specifically, the holding portion 32 is formed in a tubular shape surrounding the outer peripheral portion of the speaker unit 20, and a rectangular groove 42 that opens radially inward is formed in the inner peripheral face of the holding portion 32. The rectangular groove 42 is configured by a vertical side face 32A facing the side face of the front cover 24, a front side face 32B extending radially inward from the front end of the vertical side face 32A, and a rear side face 32C extending radially inward from the rear end. The holding portion 32 is configured such that the outer peripheral portion of the front cover 24 is fitted inside the rectangular groove 42 and held. The front end of the vertical side face 32A indicates the end part of the vertical side face 32A at the front side of the speaker unit 20, and the rear end of the vertical side face 32A indicates the end part of the vertical side face 32A at the rear side of the speaker unit 20.

Further, a linear projection 50 is provided at the vertical side face 32A of the rectangular groove 42 to improve airtightness between the holding portion 32 and the speaker unit 20. The linear projection 50 is formed in an annular shape along the circumferential direction of the holding portion 32, and is formed in a triangular shape protruding toward the side face portion 24B (outer peripheral portion) of the front cover 24. In the present embodiment, plural linear projections 50 are provided along the axial direction of the holding portion 32.

As shown in FIG. 3A, at the tip portion of the linear projection 50, the inner diameter of the holding portion 32 is slightly smaller than the outer profile of the side face portion 24B (the outer diameter of the front cover 24). As a result, when the outer peripheral portion of the front cover 24 is accommodated inside the rectangular groove 42, the tips of the linear projections 50 are elastically deformed and squashed, and tightly contact the side face portion 24B of the front cover 24. As shown in FIG. 3B, the linear projection 50 adheres to the entire circumference of the side face portion 24B, whereby a sealed state is achieved in which a gap is not formed between the front cover 24 and the holding portion 32. As a result, air leakage between the outer peripheral portion of the front cover 24 and the holding member 30 can be suppressed.

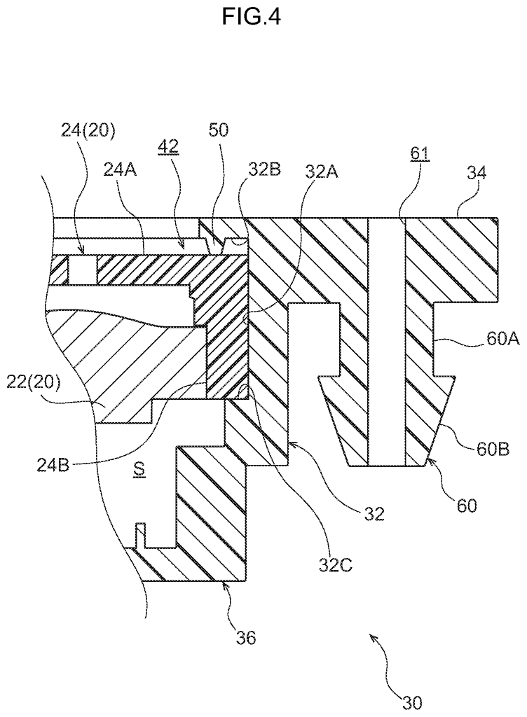

In the present embodiment, the configuration is such that the linear projections 50 are provided on the vertical side face 32A of the rectangular groove 42; however, when the linear projections 50 are provided, it is sufficient that they are arranged so as to provide sealing along the entire circumference of the outer peripheral portion of the front cover 24. Therefore, as shown in FIG. 4, a linear projection 50 may be provided on the front side face 32B of the rectangular groove 42. The linear projection 50 shown in FIG. 4 is provided in an annular shape along the entire circumference of the front side face 32B and is formed in a triangular shape protruding toward the front face portion 24A of the front cover 24. When the outer peripheral portion of the front cover 24 is accommodated inside the rectangular groove 42, the linear projection 50 closely contacts the front face portion 24A of the front cover 24. Further, from the same point of view as in FIG. 4, the linear projection 50 may be provided at the rear side face 32C of the rectangular groove 42.

As shown in FIG. 2, the attachment portion 34 of the holding member 30 is configured by a plate-like portion extending radially outward from the outer face of the holding portion 32. Plural (three in this embodiment) attachment portions 34 are provided along the circumferential direction of the holding portion 32, with the axial direction of the holding portion 32 being the plate thickness direction thereof. When the holding member 30 is attached to the rear case 16, the attachment portion 34 is installed in the accommodation recess 18 of the rear case 16 (see FIG. 1).

A fixing portion 60 that protrudes toward the side of the rear face 20B of the speaker unit 20 is provided at the lower face of the attachment portion 34. The fixing portion 60 is provided integrally with the attachment portion 34 and is made of an elastic material. The fixing portion 60 has a cylindrical column portion 60A and a hook portion 60B provided on the leading end side of the column portion 60A and protruding radially outward from the column portion 60A. The hook portion 60B is formed in a truncated cone shape whose diameter is reduced toward the leading end. A through hole 61 is formed in the attachment portion 34 so as to penetrate from the front face side of the attachment portion 34 to the leading end side of the fixing portion 60.

As shown in FIG. 1, an attachment hole 44 corresponding to the fixing portion 60 of the holding member 30 is formed in the accommodation recess 18 of the rear case 16. The inner diameter of this attachment hole 44 is formed to have substantially the same dimension as the outer diameter of the column portion 60A of the fixing portion 60. Further, the inner diameter of the attachment hole 44 is formed to be smaller than the outer diameter of the base end side of the hook portion 60B. Further, the inner diameter of the attachment hole 44 is formed to be larger than the outer diameter of the leading end of the hook portion 60B. As a result, the leading end of the hook portion 60B can be inserted into the attachment hole 44 of the accommodation recess 18 and easily aligned. Further, by pressing the attachment portion 34 from the rear side of the rear case 16 toward the accommodation recess 18 side, the base end side of the hook portion 60B can be elastically deformed and inserted into the attachment hole 44. When the entire hook portion 60B passes through the attachment hole 44, the column portion 60A is inserted into the attachment hole 44, and the hook portion 60B is elastically restored and engages with the peripheral edge of the attachment hole 44. By inserting the fixing portion 60 into the attachment hole 44 in this manner, the attachment portion 34 can be fixed to the rear case 16. As a result, the speaker unit 20 is fixed to the rear case 16 via the attachment portion 34.

According to the above-described configuration, the holding member 30 functions as a vibration absorption member that absorbs vibration propagated from the speaker unit 20. That is, by fixing the speaker unit 20 and the rear case 16 together via the attachment portion 34 formed of an elastic material, vibration transmitted from the speaker unit 20 can be absorbed by the attachment portion 34. In terms of enhancing the function of the holding member 30 as a vibration absorption member, the holding member 30 is preferably a member that is softer than the frame 28 and the front cover 24 of the speaker unit 20. In the present embodiment, as an example, the holding member 30 is formed of an elastic material such as EPDM (ethylene propylene diene rubber), CR (neoprene rubber), or Si (silicon rubber), and the frame 28 and the front cover 24 of the speaker unit 20 may be made of hard plastic such as ABS or PBT.

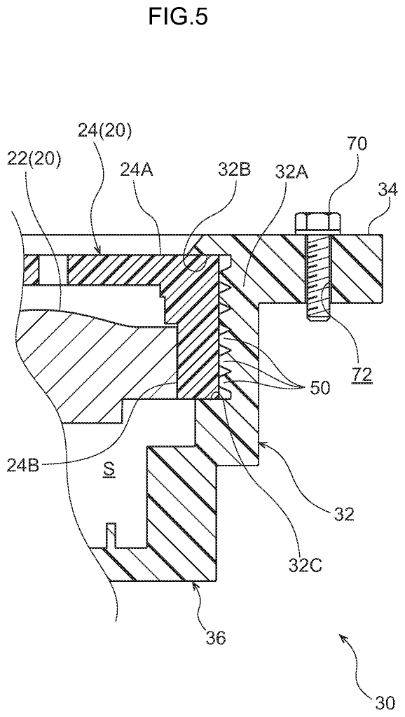

In the present embodiment, the configuration is such that the fixing portion 60 is provided integrally with the attachment portion 34; however, a configuration in which the fixing portion 60 is not provided at the attachment portion 34 may be adopted. In this case, the attachment portion 34 may be fixed to the rear case 16 using a screw 70 as shown in FIG. 5. A through hole 72 corresponding to the attachment hole 44 formed in the accommodation recess 18 of the rear case 16 is formed in the attachment portion 34 shown in FIG. 5. A configuration may be adopted in which the screw 70 is screwed into and fastened with a bolt (not shown) in a state in which it is inserted into the through hole 72 of the attachment portion 34 and the attachment hole 44 of the rear case 16. Alternatively, a configuration may be adopted in which the attachment hole 44 of the rear case 16 is a screw hole, and the screw 70 is screwed into and fastened with the attachment hole 44.

Further, as shown in FIG. 3B, the enclosure portion 36 of the holding member 30 is formed in a box shape surrounding the rear face 20B of the speaker unit 20, and has a function of separating sound emitted from the rear face 20B of the speaker unit 20 from sound emitted from the front face 20A of the speaker unit 20. Specifically, the enclosure portion 36 has a peripheral wall portion 36A extending from the rear end of the holding portion 32 to the rear face side of the speaker unit 20 and a bottom wall portion 36B joining the rear end of the peripheral wall portion 36A, whereby a bottomed cylindrical shape is formed that is open toward the side of the front face 20A of the speaker unit 20. The wiring 4 of the speaker unit 20 is inserted through the center of the bottom wall portion 36B, and an insertion hole 46 extending toward the meter board 3 is formed (see FIG. 1). Since the insertion hole 46 is formed sufficiently smaller than the area of the bottom wall portion 36B, inside the enclosure portion 36, a space section S that is almost a sealed space is formed at the rear face 20B side of the speaker unit 20. In other words, the internal space of the enclosure portion 36 configures the rear space (back cavity) of the speaker unit 20. Further, in FIGS. 2 and 3, the insertion hole 46 formed in the enclosure portion 36 is omitted.

In the enclosure portion 36, sound emitted from the rear face 20B of the speaker unit 20 can be confined inside and separated from sound emitted from the front face 20A of the speaker unit 20. Therefore, it is possible to inhibit the sound emitted from the front face 20A and the sound emitted from the rear face 20B of the speaker unit 20 from interfering and canceling each other out, which is advantageous for correct reproduction of low frequencies.

Further, adjustment of the acoustic characteristics of the speaker 1 can be performed by adjusting the inner volume of the rear space (back cavity) of the speaker unit 20 in accordance with the dimensions and shape of the enclosure portion 36. That is, in the present embodiment, since adjustment of the acoustic characteristics of the speaker 1 can be completed at the stage of design of the speaker 1, a complicated structure for adjusting acoustic characteristics is not required at the attachment target side. Therefore, there is the advantage that it is possible to avoid the trouble of adjusting the acoustic characteristics at the attachment target side to which the speaker 1 is attached.

A configuration may be adopted in which the back pressure of the diaphragm 26 is released to the rear space R of the case 10 through the insertion hole 46 by increasing the inner diameter of the insertion hole 46. Conversely, in order to improve the airtightness of the inside of the enclosure portion 36, the insertion hole 46 may be covered with a sealing material or the like. The position of the insertion hole 46 is not limited to the center of the bottom wall portion 36B, and can also be formed in the peripheral wall portion 36A or the like. When the insertion hole 46 is formed in the peripheral wall portion 36A, the wiring 4 of the speaker unit 20 can be pulled out from the side face of the holding member 30 and connected to the meter board 3. While the connecting portion between the connector 5 of the wiring 4 and the meter board 3 may be arranged inside the case 10, in a case in which the connector 5 of the wiring 4 is connected to the end of the meter board 3, the connecting portion with the connector 5 may be exposed to the outside of the case 10. When the connecting portion with the connector 5 is exposed to the outside of the case 10, since the operation for connecting the meter board 3 and the connector 5 can be performed after the speaker 1 is attached, this is advantageous in terms of increasing the degree of freedom in the assembly operation process.

### Mechanism and Effects

As described above, in the speaker 1 according to the present embodiment, the speaker unit 20 and the rear case 16 (case 10) that is the attachment target are fixed via an attachment portion 34 made of an elastic material. As a result, since vibration of the speaker unit 20 is absorbed by the attachment portion 34, vibration is less likely to propagate to the attachment target. As a result, it is possible to suppress unnecessary sound emitted from the rear case 16 owing to vibration transmitted from the speaker unit 20. Moreover, by integrally providing the attachment portion 34 and the holding portion 32, the number of parts is reduced, and the operation of assembling the speaker 1 to the case 10 can be simplified.

Further, as shown in FIGS. 3A and 3B, by forming the holding portion 32 with a resilient material, the outer peripheral portion of the speaker unit 20 can be held by the holding portion 32 while the holding portion 32 is elastically deformed. Accordingly, no adhesive is required to hold the speaker unit 20 at the holding portion 32. In this respect as well, the assembly operation can be simplified.

In the present embodiment, the rear face 20B of the speaker unit 20 is surrounded by the enclosure portion 36. That is, the holding member 30 of the present embodiment forms a so-called “sealed-type” enclosure. Accordingly, the internal volume of the rear space (back chamber) of the speaker unit 20 can be arbitrarily set in accordance with the size and shape of the enclosure portion 36, and the acoustic characteristics of the speaker 1 can be adjusted. Therefore, adjustment of the acoustic characteristics can be completed at the stage of design of the speaker 1, and the inconvenience of adjusting the acoustic characteristics at the side of the case 10 to which the speaker 1 is attached can be avoided.

Further, in the present embodiment, the outer peripheral portion of the speaker unit 20 is held by a rectangular groove 42 formed in the holding portion 32. Here, since the holding portion 32 is made of a resilient material, the elastic restorative force of the holding portion 32 can be used to bring the side face of the rectangular groove 42 into close contact with the outer peripheral portion of the speaker unit 20. Therefore, it is possible to ensure airtightness between the holding portion 32 and the speaker unit 20, and to suppress deterioration of sound pressure and sound quality due to air leakage.

Furthermore, linear projections 50 projecting toward the outer periphery of the speaker unit 20 are formed on the side faces of the rectangular groove 42. As a result, part of the side face of the rectangular groove 42 can be actively brought into close contact with the outer peripheral portion of the speaker unit 20. Thereby, airtightness between the holding portion 32 and the speaker unit 20 can be reliably obtained.

Further, the holding member 30 of the present embodiment is configured to be fixed to the case 10 by inserting the fixing portion 60 provided integrally with the attachment portion 34 into the attachment hole 44 of the rear case 16. As a result, tools such as a screwdriver are not required when fixing the holding member 30 to the case 10, so that the assembly operation of the speaker to the attachment target can be further simplified.

Furthermore, the rear case 16 is provided with an accommodation recess 18 into which the holding member 30 and the speaker unit 20 are fitted. The holding member 30 fixes the attachment portion 34 to the rear case 16 in a state in which it is fitted into the accommodation recess 18. As a result, unevenness of the surface of the rear case 16 can be reduced, and interference between the speaker unit 20 and the peripheral members of the meter device 2 can be suppressed.

### Supplementary Explanation

While examples of embodiments of the present disclosure have been explained above, the present disclosure can be modified as appropriate without departing from the gist of the invention, and omission, replacement, and modification of the configurations in the embodiments described above and the respective modified examples can be performed.

For example, in the above-described embodiments and each modified example, the speaker unit 20 is configured to include the front cover 24; however, the present disclosure is not limited to this, and the present disclosure can also be applied to speaker units that do not include the front cover 24. In this case, the outer peripheral portion of the main body 22 of the above-described embodiment—that is, the outer frame portion of the frame 28—becomes the outer peripheral portion of the speaker unit and is held by the holding portion 32.

Further, in the above-described embodiment, the holding member 30 configures the enclosure of the speaker 1; however, the present disclosure is not limited to this. For example, the holding member may be configured by a front cover that covers the front face of the speaker unit, and the configuration may be such that the holding portion and the attachment portion are provided integrally with the front cover.

Further, the holding member may be configured by the holding portion 32 and the attachment portion 34 in the above-described embodiment, and may be configured without including the enclosure portion 36. Further, in the above-described embodiment, the holding member 30 is a “sealed-type” enclosure; however, the present disclosure is not limited to this, and a holding member that configures a “rear face open-type” enclosure, having the bottom wall portion 36B removed from the enclosure portion 36, may be applied to the present disclosure. In addition, holding members that configure various enclosures, such as a flat baffle-type and a bass reflex-type, can be applied to the present disclosure.

Further, in the above-described embodiment, the linear projections 50 are configured in a triangular shape; however, the present disclosure is not limited to this. It is sufficient that the linear projection and the outer peripheral portion of the speaker unit are configured to be able to be in line contact, and the projection may be a linear projection having a hemispherical cross section or a linear projection having a trapezoidal shape. Further, the number of linear projections 50 can be appropriately set as required, and may be one, or plural projections may be provided as in the above-described embodiment. Furthermore, a configuration in which the linear projections 50 are not provided in the rectangular grooves 42 may be employed. However, by providing plural linear projections, it is possible to obtain more reliable sealing between the holding portion and the speaker unit.

In the above-described embodiment, the accommodation recess 18 that houses the holding member 30 is formed in the rear case 16 that is the attachment target; however, the present disclosure is not limited to this. A configuration may be employed in which only the substantially circular opening 19 is formed in the planar portion of the rear case 16.

Further, in the above-described embodiment, the configuration is such that the speaker 1 is attached to the meter device 2 installed in the vehicle; however, the present disclosure is not limited to this. The attachment target of the speaker 1 can be changed as appropriate, and for example, the attachment target may be a door inner panel, a pillar, or the roof of a vehicle. In addition, the casing of various devices other than the vehicle may be the attachment target.

The disclosure of Japanese Patent Application No. 2020-198974 filed on Nov. 30, 2020, is incorporated herein by reference in its entirety.

All publications, patent applications and technical standards mentioned herein are incorporated herein by reference to the same extent as if each individual publication, patent application and technical standard were specifically and individually indicated to be incorporated by reference.

1. A speaker, comprising:
a speaker unit; and
a holding member configured to hold the speaker unit,
wherein the holding member is formed of a resilient material, and has a holding portion configured to hold the speaker unit and an attachment portion provided integrally with the holding portion and configured to be fixed to an attachment target.

2. The speaker of claim 1, wherein the holding member has an enclosure portion that surrounds a rear face of the speaker unit.

3. The speaker of claim 1, wherein a rectangular groove configured to hold an outer peripheral portion of the speaker unit is formed at the holding portion.

4. The speaker of claim 3, wherein: a linear projection protruding toward the outer peripheral portion is formed at a side face of the rectangular groove, and the holding portion closely contacts the outer peripheral portion via the linear projection.

5. The speaker of claim 1, wherein a fixing portion, configured to be inserted into an attachment hole formed in the attachment target and fixed, is provided at the attachment portion.

6. A speaker attachment structure configured to attach the speaker of claim 1 to an attachment target, wherein:
an accommodation recess is formed at the attachment target, and
the attachment portion of the holding member is fixed to the attachment target in a state in which the holding member is embedded in the accommodation recess.
